(19) United States
(12) Patent Application Publication
(10) Pub. No.: US 2011/0102890 A1
(43) Pub. Date: May 5, 2011

(54) Display device with lens effect

(76) Inventor: Michael Eastman, St. Louis, MO (US)

(21) Appl. No.: 12/590,212

(22) Filed: Nov. 4, 2009

(51) Int. Cl. G02B 27/22; B32B 37/02

(52) U.S. Cl. 359/478; 156/60

(57) ABSTRACT

The invention provides a display device in which an intermediate layer disposed between a first image and a second image acts as a lens to create a unique three dimensional visual effect. The invention further provides methods of creating such display devices.

### FIELD OF THE INVENTION

The present invention generally relates to the field of new and useful three-dimensional visual effects and images.

### BACKGROUND OF THE INVENTION

Two-dimensional images, such as standard photographs, drawings, diagrams, illustrations, paintings, cartoons, and other artistic renditions, generally lack depth of image. A wide variety of attempts have been employed in an effort to provide illusions of visual depth to two-dimensional images. For example, some prior art designs employ mirrors and reflected images to provide an illusion of depth and three-dimensions, such as in U.S. Pat. No. 5,787,618. Others have employed holograms in an attempt to create the impression of three-dimensional depth. Some prior art efforts have attempted to create an illusion of realism in thin products such as trading cards by adhering a sheet containing a photograph to a sheet in the same shape as the image in the photograph, the two combined sheets then adhered to a background sheet that contains an outline of the image or photograph, such as disclosed in U.S. Pat. No. 5,421,583. Yet others have attempted to affix images to two translucent textures sheets and placing the sheets adjacent each other to create an artistic effect, such as shown in U.S. Pat. No. 7,294,221.

Such prior art designs have significant limitations. For example, the designs described in U.S. Pat. Nos. 5,787,618 and 5,421,583, attempt to create a three-dimensional effect by using a “shadow.” These devices do not create particularly effective three-dimensional designs and, moreover, are ill-suited for more complex images. The artistic medium described in U.S. Pat. No. 7,294,221 requires that both images be translucent and must be back lit for full artistic effect. Further, the described apparatus requires that the substrate be textured, as dictated by the image used. Thus, such a described structure appears to be extremely limited to situations in which the device can be back lit, texturing is required to attempt to produce a three-dimensional impact, and translucency of the device is appropriate, resulting in limited visually enhanced effects.

Thus, a need exists for a display device that creates a more realistic illusion of depth and/or a three-dimensional effect without limitations of employing shadows, simplistic images, flexible substrates, textured substrates, and/or translucency of the device.

### SUMMARY OF THE INVENTION

The present invention teaches a new and useful display device employing, preferably, at least one intermediate layer disposed between a first image (or first image layer) and a second image (or second image layer). The images included in the first image and second image can be the same or varied depending upon the desired image effect. Preferably, the first image and the intermediate layer are transparent. Importantly, the intermediate layer of the invention serves as a lens; thus, a preferred display device of the invention creates a unique and unexpected three-dimensional visual effect when a viewer observes the first layer and, at the same time, the second layer, through both the first layer and the intermediate lens layer.

The intermediate layer of the present invention, which serves as a lens, preferably comprises primarily glass, acrylic, plastic, or a material having similar characteristics, and is sufficiently thick to distort an image viewed through the intermediate layer via a lens effect and, when viewed in combination with the first image, creates a unique three dimensional effect. Other features, such as lighting devices, objects (e.g., an object similar to an object depicted in a first and/or second image), and/or other materials may be included in an intermediate layer of the invention.

Display devices of the present invention have a number of both aesthetic and functional uses. For example, the display devices of the present invention may be used as artwork, e.g., as pictures, wall hangings, or demonstrative devices. Such display devices may also be used in a more functional manner, such as in architectural signage, commercial illustrations, commercial signage, doors, shower doors, wall clocks, windows (including, for example, stained glass windows), table top surfaces, room partitions, and neon sign surfaces, both indoor and outdoor.

A display device of the present invention preferably comprises, in one embodiment, a first image and a second image which are substantially identical images and in which the first image, or portions of the first image, is substantially transparent. “Transparent” refers to an object or material through which an image, object, or the like, placed behind the first object or material can be seen with relative clarity. A transparent material may be described as “see-through.” Film base, such as nitrocellulose, cellulose acetate, or polyethylene teraphthalate, is an example of a transparent material that might comprise a first image of the invention.

A transparent material employed in the present invention may be clear and/or may comprise one or more colors. For purposes of this invention, optical transparency is not necessary and, accordingly, “transparency” may, but need not, be interpreted to refer to true optical transparency. Furthermore, as will be understood by those of skill in the art, and apparent from the description that follows, elements of the present invention may have some portions that are transparent or nearly transparent and others more properly described as translucent or even opaque. For example, a “transparent” image or a “transparency” may have some portions that are clear or nearly clear and others that substantially block the passage of light.

A first and second image of a display device of embodiments of the present invention may have substantially similar degrees of transparency or may differ in their degree of transparency. In one embodiment, a difference in degree of transparency between a first image and a second image is achieved by providing denser coloring on one image than on another, e.g., a portion of an image that appears as a medium gray on a first image may appear as dark gray on a second image. In another embodiment, the first image may be more transparent than the second image. The second image may be transparent, translucent, or opaque. The differentiation of transparency and/or color, in conjunction with the lens of the invention, provide unexpected results including, for example, novel realistic three-dimensional visual appearances, in some embodiments the illusion of solid surfaces in the intermediate layer, and in some embodiments the illusion of flickering light (without the employment of any lighting devices, or intermittent lighting).

As will be understood by those of skill in the art, “translucent” generally refers to materials through which an image or object behind the material can be seen, but not clearly; e.g., the image (as seen through the translucent material) may be blurry but identifiable or, at a higher level of translucency, may be unidentifiable. “Opaque” typically describes an object or material which reflects light rather than allows the passage of light through such object or material. As will be further understood, in the continuum between a material that is completely transparent and one that is completely opaque, a material might be variously referred to as “transparent,” “semi-transparent”, “partially transparent,” “translucent,” “semi-translucent,” “partially translucent,” “opaque,” “semi-opaque”, “partially opaque,” and the like, depending upon the characteristics of the material; furthermore, in some instances, some such terms, such as “semi-transparent” and “translucent” may be synonymous and/or properly refer to the same material and/or object.

In another embodiment, a first and second image are black and white images in which one is the “negative” of the other. Colors may also be used in addition to black and white images provided in “reverse” or “negative” to enhance the artistic effect. Use of color may be employed to enhance the three-dimensional effect, e.g. by providing red on a first image (which may appear to advance) and by providing blue on a second image (which may appear to recede). Unexpectedly, when such images are provided on either side of an intermediate lens layer in a display device of the present invention, and when such images further comprise text or other text-like forms (which may be rendered in “reverse” or “negative” forms on the respective images), the three dimensional illusion of the invention is especially enhanced, and may result in the further illusion of solid edges or surfaces in the intermediate lens layer.

The invention further provides methods of creating a display device comprising, in one embodiment, placing a first image on a first side of an intermediate layer and placing a second image on a second side of an intermediate layer. A method of the invention may further comprise additional steps of placing a second intermediate layer between the second image and a third image. The method may comprise further alternating intermediate layers and images until the desired visual effect is achieved employing the lens features of the present invention.

These and other aspects and embodiments of the present invention are more fully described below.

### DESCRIPTION OF THE DRAWINGS

The invention will be better understood from a reading of the following detailed description, taken in conjunction with the accompanying Figures in the drawings in which:

FIG. 1 is a perspective view of one embodiment of the display device of the present invention;

FIG. 2 is a side view of one embodiment of the display device of the present invention, showing a first image layer, an intermediate layer, and a second image layer;

FIG. 3 is a photograph of a perspective view of an embodiment of a disassembled display device of the present invention;

FIG. 4 is a photograph of a perspective view of the assembled display device of FIG. 3;

FIG. 5 is a photograph of a front view of the display devise of FIG. 4;

FIG. 6 is a photograph of a front, side perspective view of the display device of FIG. 4;

FIG. 7 is a photograph of a front, side perspective view of a display device according to an embodiment of the present invention;

FIG. 8 is a photograph of a front, side perspective view of a display device according to an embodiment of the present invention;

FIG. 9 is a photograph of a front, side perspective view of a display device according to an embodiment of the present invention; and

FIG. 10 is a photograph of a front, side perspective view of a display device according to an embodiment of the present invention.

For simplicity and clarity of illustration, the figures illustrate the general manner of construction of one embodiment of the invention; descriptions and details of well-known features and techniques may be omitted to avoid unnecessarily obscuring the invention. Additionally, elements in the figures are not necessarily drawn to scale. The same reference numerals in different figures denote the same elements.

The terms “first,” “second,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

### DETAILED DESCRIPTION OF THE INVENTION

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyrights whatsoever.

The invention provides a new, unique, and aesthetically pleasing display device and methods of creating a display device. A display device of the invention preferably comprises an intermediate layer disposed between a first image and a second image, in which the intermediate layer acts as a lens to converge, diverge, and/or otherwise refract beams of light passing through the first image and the intermediate layer and in which the second image is at least partially visible when viewed through the first image and intermediate layer. Preferably, the convergence, divergence, and/or refraction of the beams of lights causes the second image to appear different from the first image, and in some cases distorted, when viewed through the first image and intermediate lens layer. Thus, unlike the known prior art devices, the unique and enhanced visual effect achieved by the display device of the present invention does not require a substrate cut to the shape of a person or simplistic object in which a visual effect is achieved by employing a shadow, nor does it require texturing of a substrate to “match” an image to achieve a visual effect.

“Image” and the like, as used herein, should be broadly understood to refer to and include a photograph, painting, drawing, diagram, illustration, cartoon, handwriting, text, typeface, icons, computer generated graphics, and/or other artistic renditions and/or visual images.

“First image” and the like refers to the image and/or set of images that is on, affixed to, adjacent, or placed in proximity to, a first side of the intermediate layer. For example, a first image may be a photograph that comprises, inter alia, images of a flower, a table, and a bowl of fruit. A “first image” may be a collage of images on a first side of an intermediate layer, e.g., a portion of a photograph, a portion of a reproduction or copy of a painting or other image, an original image produced directly on the intermediate layer and/or portions of the first image (for example, via paint, ink, or other artistic medium), and the like. Further, by way of example, a first image may comprise a drawing, icon, picture, or the like, in combination with series or lines of text, type, half-tones, and other. figures as will be appreciated by those of skill in the art. Thus, a first image may comprise one or more images, series of images, and layers of images.

One or more of the images comprising a first image may be produced, in one embodiment, directly onto and/or into the first side of the intermediate layer, e.g., by painting, drawing, etching, photocopying, printing, and the like. One or more of the images comprising a first image may be produced, reproduced, and/or otherwise provided on a substrate, such as film base, transparency film, paper, plastic, or other material which material is then adhered, connected, glued, clipped, and/or otherwise affixed to and/or placed in contact with or adjacent to the first side of the intermediate layer. For example, a first image may be “affixed” or “attached” to an intermediate layer by a frame or other mechanism that holds the first image and the intermediate image in place. Enhanced three-dimensional effects of the invention may be achieved by sandwiching the first image between a first outer substantially transparent medium (e.g., a first lens layer) and the intermediate lens layer, and, optionally, the second image sandwiched between a second outer substantially transparent medium and the intermediate lens layer. The first outer transparent medium, depending upon its thickness, may serve as an initial lens thereby enhancing the three-dimensional effect of the invention.

In an embodiment of the invention in which a first image comprises one or more images provided on a substrate, such a first image (or such portion thereof) may be referred to as a “first image layer.” Reference herein to a “first image” shall include a first image layer unless the context clearly requires otherwise.

“Second image” and the like refers to the image and/or set of images that is on, affixed to, adjacent, or placed in proximity to, a second side of the intermediate layer. As with a first image, a “second image” may be a collage of images on a second side of an intermediate layer and may comprise one or more layers of images. Furthermore, images comprising a second image may be produced directly onto and/or into the second side of the intermediate layer and/or may be produced, reproduced, and/or otherwise provided on a substrate, such as film base, transparency film, paper, plastic, fabric, wood, metal, or other material which material is then adhered, connected, glued, clipped, and/or otherwise affixed to and/or placed in contact with or adjacent to the first side of the intermediate layer. In an embodiment of the invention in which a second image comprises one or more images provided on a substrate, such a second image (or such portion thereof) may be referred to as a “second image layer.” Reference herein to a “second image” shall include a second image layer unless the context clearly requires otherwise.

As will be understood by those of skill in the art, if the second image is to be visible through the first image and an intermediate lens layer, the first image (or portions thereof) and the intermediate layer must be, at least, translucent and, preferably, substantially transparent. Specifically, the second image is preferably visible through the first image (or portions thereof) and the intermediate layer with some degree of clarity. Thus, an observer viewing a display device would see the first image and the second image, wherein the second image is distorted due to the refractive characteristics and/or lens effect of the intermediate layer.

In one embodiment, the first image and second image employ essentially the same image, e.g., both comprise the same photographic image or artistic impression. The first image and second image may comprise the same image, but in which such image of the first image differs from the image of the second image in color, shade, hue, size, and/or degree of transparency and/or translucency. Further the first image and the second image may be derived from the same image, but each image may include or omit certain elements or components of the image. In one embodiment, the degree of transparency (or translucency) of the first image and the second image are substantially the same. In another embodiment of the invention, one or more images of the first image is more transparent than the corresponding same or substantially similar image of the second image. Depending on the embodiment and the intended use of a display device of the invention, a second image that is opaque or nearly opaque may be preferred, e.g., so that no image or object is visible (or, at least, visible with any significant degree of clarity) through the second image. Thus, the unique visual effect of a display device of the present invention may be achieved without backlighting and/or a translucent second image, expanding the uses for a display device of the present invention well beyond those of prior art display devices.

In other embodiments, a second image that is more transparent than the first image may be used. The desired degree of transparency, translucency, and/or opaqueness of the second image may be provided by the second image, e.g., by the level of pigment of the second image and/or by material composing a second image layer. Alternatively or additionally, it may be provided by a light control layer placed behind the second image (e.g., on the side opposite the intermediate layer). For example, an opaque or semi-opaque material, such as plastic, paper, fabric, metal, wood, and the like may be placed behind the second image to prevent visibility through the second image and/or to increase the aesthetic effect of a display device of the invention according to such an embodiment.

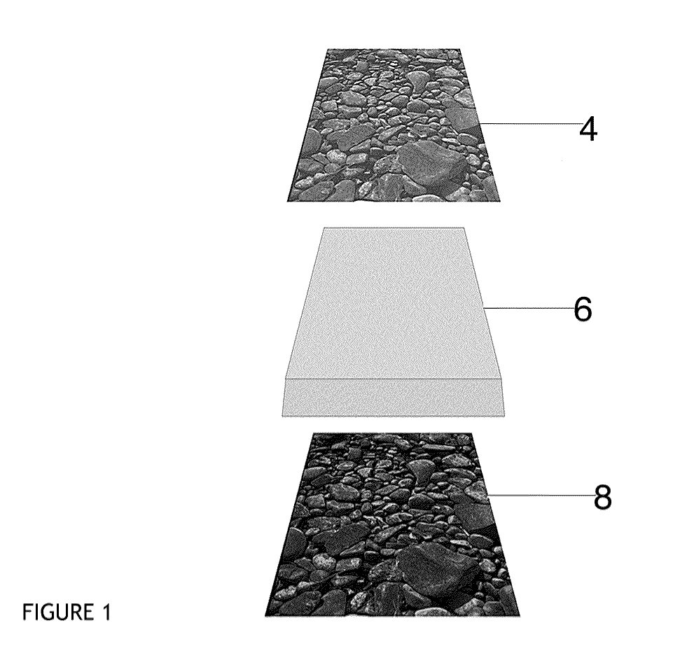

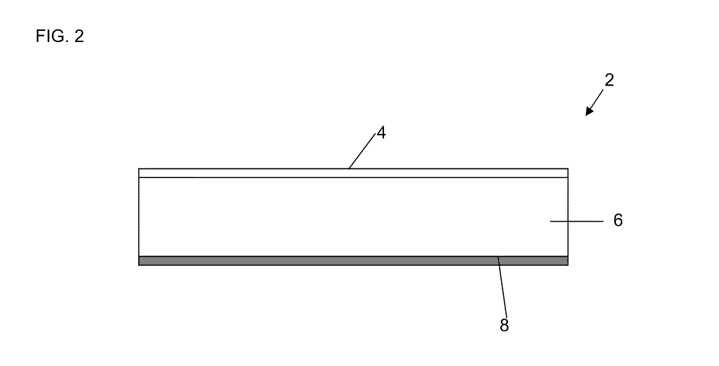

In the embodiment illustrated in FIG. 1, a first image layer 4 and a second image layer 8 each comprise a reproduction of the same photographic image on a substrate in which the second image layer 8 is opaque, translucent, or transparent and the first image layer 4 is transparent.

The intermediate layer 6 of a display device of the invention preferably comprises one or more materials and/or substances that provide lens-like characteristics and are translucent or, preferably, transparent or semi-transparent and that converges, diverges, and/or otherwise refracts beams of light that pass through it. In one embodiment, an intermediate layer 6 comprises one or more acrylic resins, polycarbonates, and/or other plastics, such as polymethyl methacrylate. Alternatively and/or additionally; an intermediate layer of the invention may comprise glass.

The lens effect of an intermediate layer 6 of a display device of the present invention (as such lens effect is described herein) requires an intermediate layer 6 of something more than nominal thickness in order to achieve the lens effect of the present invention. In particular, the intermediate layer 6 preferably is at least approximately one-eighth inch thick, wherein “thick” refers to the distance from the first side of the intermediate layer 6 to the second side of the intermediate layer 6. In another embodiment, an intermediate layer 6 is preferably at least approximately one-fourth inch thick. Particularly preferred is an intermediate layer 6 that is between approximately one-fourth inch thick and approximately two inches thick. A preferred thickness of the intermediate layer 6 in the present invention will often depend upon the first image 4 and/or second image 8. For example, if a first image 4 and second image 8 comprise a photograph shot with a wide angle lens, a thickness of approximately ¼ inch might be preferred for the intermediate layer 6 to achieve a desirable lens effect; however, with a photograph that is taken with a normal or telephoto lens, a preferred thickness might be approximately 1 inch.

In a preferred embodiment of a display device 2 of the invention, such as the embodiment illustrated on FIG. 1, the intermediate layer 6 is substantially flat and of substantially uniform thickness, such that the first image 4 and second image 8 are substantially parallel. In other embodiments, all or a portion of the intermediate layer 6 may be curved, cylindrical, wavy, and/or otherwise uneven, slanted, and/or varied, to achieve varied and optimal visual lens effects.

The intermediate layer 6 may be substantially uniform in composition. Alternatively, the composition of an intermediate layer 6 may vary along its length, width, circumference, or other dimension, to achieve varying visual lens effects. The intermediate layer 6 may comprise elements other than the translucent, transparent, and/or semi-transparent substances and/or materials described above. For example, in some embodiments, light emitting diodes and/or other illuminating features may be comprised within or on an intermediate layer 6 of a display device. Other elements and/or objects may be imbedded into and/or otherwise incorporated into an intermediate layer 6, such as decorative pieces, metal, wood, and/or other objects.

In a preferred embodiment of a display device of the invention in which the first image 4 and the second image 8 are substantially identical, the second image 8 is preferably in registry or in substantial registry with the first image 4. Specifically, when a portion of a first image 4 is viewed from a point that it is substantially perpendicular to a line comprising the intermediate layer 6 (when someone is viewing the invention from a perspective directly in front of the invention), a substantially identical portion of the second image 8 is directly (or substantially directly) below or behind such portion of the first image 4. Such an alignment in such an embodiment enhances the three-dimensional lens effect of the intermediate layer 6 and provide a visually pleasing effect of the distortion of the second image 8 when viewed through the first image 4 and intermediate layer 6. Although substantially identical first and second images that are in registry or substantial registry with one another is preferred, the entire first image 4 need not be substantially identical to and/or in substantial registry with the entire second image 8. For example, offsets between the first and second images 4 and 8 employed in the present invention may also provide visually desirable effects, depending upon the image and artwork employed.

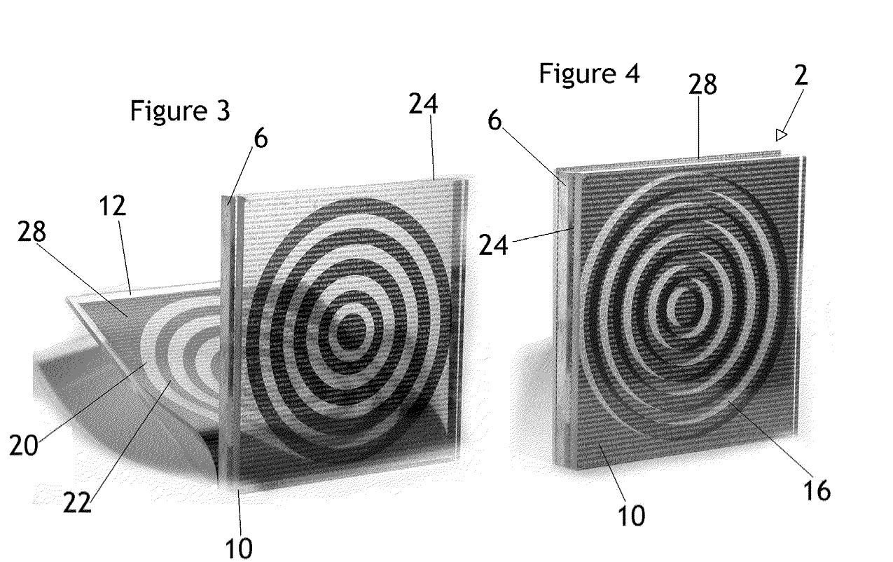

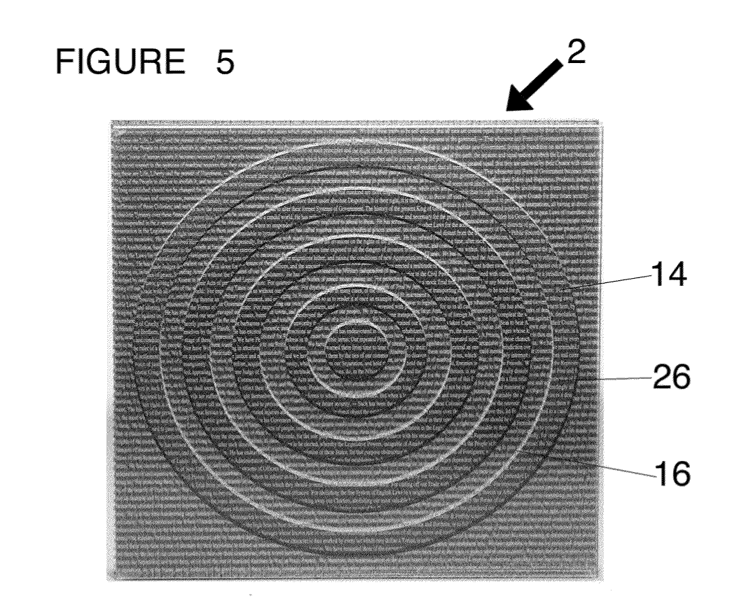

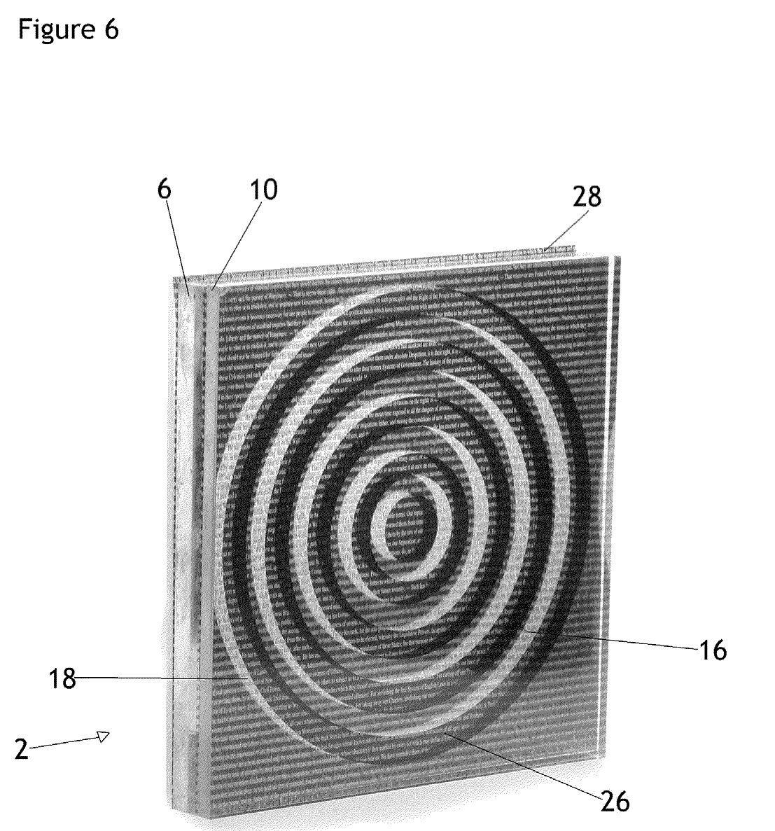

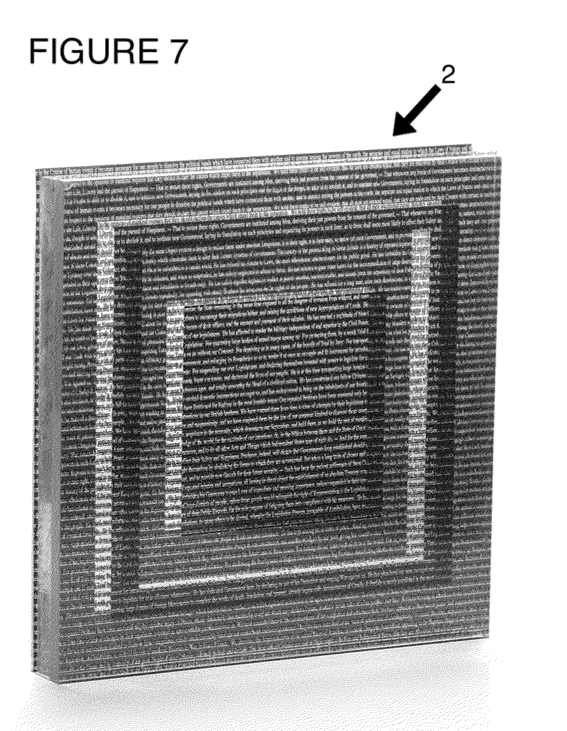

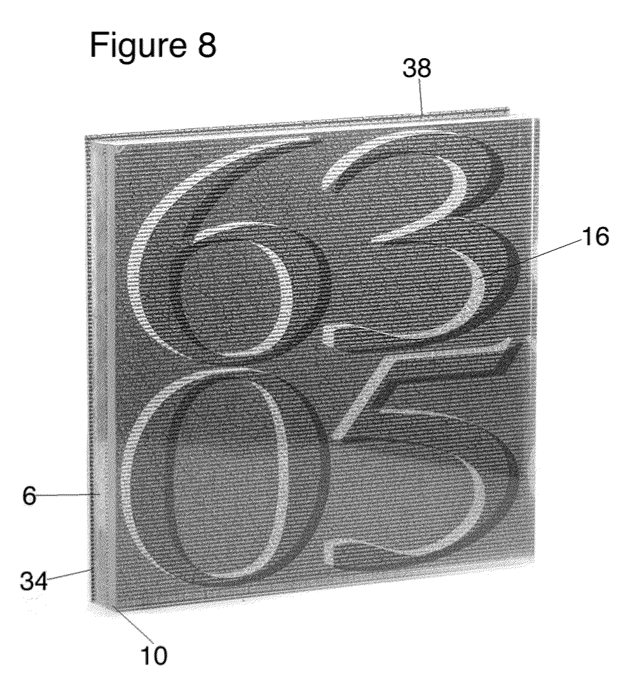

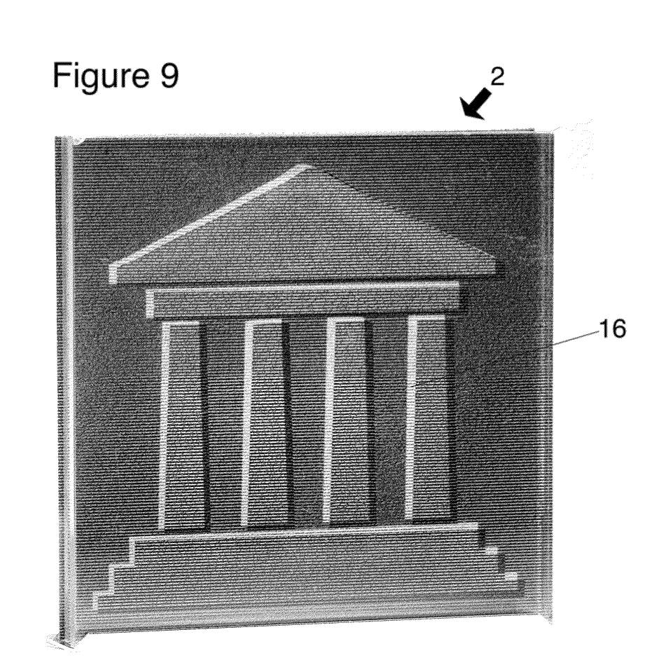

One embodiment of the invention, illustrated in FIG. 3-9, employs lines or patterns of small type face 14 (for example, 14 point font) in the first image 24. 34 and second image 28, 38. The type face 14 may be used in combination with other artwork, icons, images, or the like, on the first image 24, 34 and second image 28; 38. The unexpected results of employing the intermediate lens layer 6 in combination with the small type face achieves a remarkable three-dimensional illusion effect. Although type is illustrated, other symbols, lines, half tones, forms, and “type-like” features may be used. Thus, “type” should be broadly understood to refer to letters, numbers, symbols, lines, half tones, forms, and other or similar markings. The size of the font employed in this embodiment will vary depending upon the dimensions of the overall final product, and the distance from which an observer will view the invention. For example, where a 14 or 18 point font may be preferable for a device having dimensions of 18 inches by 24 inches and observers stand in close proximity to the work (e.g., 18 inches to 6 feet away), 60 or 80 point fonts may be preferable for a device having dimensions of 6 feet by 9 feet where observers will have a focal point many feet away from the device (e.g. 20 to 60 or more feet away).

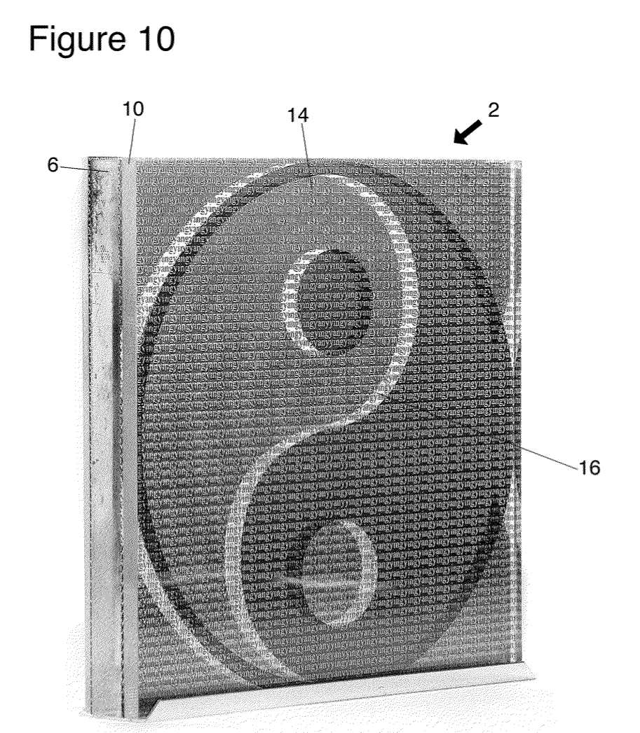

The effect is further enhanced, unexpectedly, when first and second images 24, 34 and 28, 38 of a display device of the present invention comprises type 14 and in which the first image 24, 34 is a “negative” of the second image 28, 38 and/or in which patterns, shapes, outlines, designs, or the like, are formed by employing different shades or colors. The shades or colors employed on first image 24, 34 are reversed and/or complimentary on second image 28, 38. For example, a portion of the first image 24, 34 represented by white type on a black surface will be represented by black type on a white surface on the second image 28, 38. As illustrated in FIG. 4-10, when such a first and second FIGS. 24, 34 and 28, 38 are disposed on either side of an intermediate lens layer 6, a strong, convincing, and aesthetically pleasing three dimensional effect is achieved. In addition to the three-dimensional appearance of the subject design and image, the employment of the first and second images 24, 34 and 28, 38 employing type, with the reverse or complimentary shades or colors, or white and black, result in the visual illusion of solid surfaces 16 formed within the device and, specifically, between the first image layer, the intermediate lens layer 6, and the second image layer.

A first lens layer 10, discussed in further detail below, may be used to further enhance the effect and aesthetic value of a display device of the present invention. A support layer 12 may be optionally included. In one embodiment, a display device comprises both a first lens layer 10 and a support layer 12, in which the support layer 12 comprises features applicable to an intermediate layer 6, and allows a display device of the present invention to be viewed from either side to similar effect.

Certain embodiments of the present invention, in which identical or substantially similar type and/or other images are provided on the first image and the second image, but in which they are provided in black and white as negatives of one another or as different colors, shades, or the like, produce another unexpected result. Specifically, such embodiments of the invention provide the illusion of flickering images or light without the employment of any alternating lighting devices. This unique visual effect may also be realized with any number of graphic images such as, for example, the image of a bull's-eye (i.e. target), as shown in FIG. 4-6, with the first image 24 of a bull's-eye comprising one set of colors or shades (e.g., black on white for some portions and white on black for others) and the second image 28 of a bull's-eye employing a different set of colors or shades (e.g., white on black for the portions represented by black on white on the first image)—the device of the present invention creating a unique lens effect of a flickering bull's-eye without employing of any alternating light sources or mechanical instruments.

FIG. 3. depicts a partially unassembled device of the present invention wherein the first and second images 24 and 28 are comprised of linear lines of type 14 and an image of a circular target is provided employing alternating circles of black and clear bands 20, 22. The type alternates from black to white, black when the type is in a clear portion of the image, and clear when the type is in a black portion of the image. First image 24 is the reverse or negative of second image 28, such that the alternating bands of black and clear, and corresponding alternating type of black and clear, on first image 24 are the opposite of those in second image 28. When first image 24 is disposed adjacent one side of intermediate layer 6, and second image 28 is disposed on the other side of intermediate layer 6, and the first and second images are in substantial registration with one another, as shown in FIGS. 4-6, the novel three-dimensional effect of the present invention occurs such that the type appears to have substantial and realistic depth, the target has the illusion of three-dimensional depth, and each band 26 of the target provides the illusion of having a solid exterior 18 and interior 16 surface along the circumference of the bands.

A display device of the invention may comprise more than one intermediate layer and more than two images or image layers, e.g., a display device of the present invention may comprise an additional image disposed between the first and second images, in which an intermediate layer is provided between each of the first image, the second image, and the additional image.

In an embodiment comprising multiple intermediate layers, the intermediate layers may be substantially similar or they may differ in degree of transparency, size, composition, color, and/or other features. Features applicable to a first image, first image layer, second image, and/or second image layer may also apply to a third (or other additional) image and/or a third (or other additional) image layer. In one embodiment comprising at least three images, a first image and a third image are similar in transparency and a second image (an image disposed between the first image and third image) is more opaque than the first and third images. In another embodiment, the second image is less transparent than the first image, and the third image is less transparent than the second image. Other configurations of relative degrees of transparency may be used.

A display device 2 of the invention may comprise a first lens layer 10 with features applicable to an intermediate layer, as described herein. An optional first lens layer 10 may be placed on top of a first image 4, such that the first image 4 is disposed between the first lens layer 10 and the intermediate layer 6. The optional first lens layer may further enhance the distortive effect of a display device of the invention and provide a pleasing visual effect.

A display device of the invention comprises, in some embodiments, a light feature, light source, object, or design behind the last image to enhance the aesthetic effects of a display device according to such an embodiment. Alternatively, light features may also be placed in, or between, intermediate layers, depending upon what effect is desired employing the invention.

Display devices of the present invention can be used “alone”, e.g., as artwork, or in a wide variety of applications. For example, the invention includes display devices used as and/or incorporated into table tops (and/or other table elements), countertops, room partitions, shower walls, lamp shades, light fixtures, signage, windows, clocks, mirrors, and/or other furnishings and/or objects 'd art.

The invention also provides for methods of creating a display device. In one embodiment, the invention provides a method of creating a display device comprising applying a first image to a first side of an intermediate layer and applying a second image to a second side of the intermediate layer. In another embodiment, a second intermediate layer is adhered, attached, and/or otherwise applied to the second image at a first side of the intermediate layer and a third image is applied to a second side of the second intermediate layer.

“Applying” should be broadly understood to refer to and include one or more steps (1) which result in an image produced directly onto, into, and/or adjacent to the first side of the intermediate layer, e.g., by painting, drawing, etching, carving, photocopying, printing, and the like, (2) in which an image is produced, reproduced, and/or otherwise provided on a substrate, such as film, transparency film, paper, plastic, or other material and which result in such material being adhered, connected, glued, clipped, and/or otherwise affixed to and/or placed next to the first side of the intermediate layer. Furthermore, such term should be broadly understood and include and refer to, e.g., situations where a party creating a display device of this invention has performed all of the steps that result in application of a first and second image to an intermediate layer, as well as to situations where a third party has performed one or more of the steps that result in such application.

In a further embodiment, the method may include the additional step of employing lights on, near, or within the display device to enhance the visual effect. The lights may be employed behind the display device, on the side of the display device, or embedded into the display device, or any combination thereof. However, as discussed herein, the visual effects of display devices of the present invention are not dependant upon light source from a particular direction to achieve, e.g., a particular shadow effect.

Although certain illustrative embodiments have been disclosed, it will be apparent from the foregoing disclosure to those skilled in the art that variations and modifications of such embodiments may be made without departing from the spirit and scope of the invention. Accordingly, it is intended that the invention should be limited only to extent required by the appended claims and the rules and principals of applicable law.

I claim:

1. A display device comprising
an intermediate layer, wherein the intermediate layer comprises a first side and a second side and wherein the intermediate layer is substantially transparent and refracts light;
a first image layer on the first side of the intermediate layer, wherein the first image layer comprises a first image that is substantially transparent;
a second image layer on the second side of the intermediate layer, wherein the second image layer comprises a second image that is substantially similar to the first image, and wherein the second image is visible through the first image and the intermediate layer.

2. The display device of claim 1, wherein the intermediate layer comprises a material selected from the group consisting of glass, acrylic, and plastic.

3. The display device of claim 1 wherein the first image and second image are in substantial registry.

4. The display device of claim 1 wherein the intermediate layer comprises a depth between the first side and the second side that is at least approximately 0.25 inches.

5. The display device of claim 2 wherein the intermediate layer comprises a light source.

6. The display device of claim 5 wherein the light source is a light emitting diode.

7. The display device of claim 1, wherein the first image and the second image differ in color, shade, or hue.

8. The of claim 1, wherein the first and second image are selected from the group consisting of photographs, drawings, paintings, etchings, and computer generated images.

9. The display device of claim 1 wherein the intermediate layer comprises a depth between the first side and the second side that is between approximately 0.25 inches and approximately 2 inches.

10. The display device of claim 1 wherein the intermediate layer comprises a depth between the first side and the second side that is greater than 2 inches.

11. The display device of claim 1 further comprising:
a second intermediate layer wherein the second image is between the second side of the intermediate layer and a first side of the second intermediate layer; and
a third image layer on a second side of the second intermediate layer, wherein the third image layer comprises a third image that is substantially similar to the first image and second image.

12. A display device comprising:
an intermediate layer, wherein the intermediate layer comprises a first side and a second side, a depth between the first side and second side that is at least approximately 0.25 inches, and wherein the intermediate layer is substantially transparent and refracts light;
a first image layer on the first side of the intermediate layer, wherein the first image layer comprises a first photograph; and
a second image layer on the second side of the intermediate layer, wherein the second image layer is less transparent than the first image layer and comprises a second photograph wherein the second photograph is produced from the same image as the first photograph, and wherein the second image is visible through the first image and the intermediate layer.

13. The display device of claim 12, wherein the intermediate layer comprises a material selected from the group consisting of glass, acrylic, and plastic.

14. The display device of claim 12, wherein the display device is a table top.

15. The display device of claim 12, wherein the display device is a sign.

16. The display device of claim 11 wherein the intermediate layer comprises a light source.

17. The display device of claim 16 wherein the light source is a light emitting diode.

18. A method of creating a display device, the method comprising:
providing an intermediate layer, wherein the intermediate layer comprises a first side, a second side, and a material selected from the group consisting of glass, acrylic, and plastic;
applying a first image to the first side of the intermediate layer; and
applying a second image to the second side of the intermediate layer.

19. The method of claim 18 wherein the first image and the second image are substantially identical and wherein the second image is opaque.

20. The method of claim 18 wherein the intermediate layer is between approximately 0.25 inches thick and 2 inches thick between its first side and second side.

21. The method of claim 18 further comprising:
providing a second intermediate layer comprising a first side and a second side;
adhering the first side of the second intermediate layer to the second image; and
applying a third image to the second side of the second intermediate layer.

22. The method of claim 18 wherein the first image and the second image contain small type that are in substantial alignment with one another.
